(19) United States
(12) Patent Application Publication
(10) Pub. No.: US 2026/0256174 A1
(43) Pub. Date: Sep. 3, 2026

(54) TASTE MODIFYING COMPOSITIONS AND USES THEREOF

(71) Applicant: Firmenich SA, Satigny (CH)

(72) Inventors: Robert WAGNER, Satigny (CH); Grace MAI, Singapore (SG); Sayam KANJANASIT, Bangkok (TH)

(73) Assignee: Firmenich SA, Satigny (CH)

(21) Appl. No.: 18/872,810

(22) PCT Filed: Jun. 15, 2023
(86) PCT No.: PCT/EP2023/066172

§ 371 Date: Dec. 7, 2024

Related U.S. Application Data
(60) Provisional application No. 63/355,429, filed on Jun. 24, 2022.

(30) Foreign Application Priority Data
Jul. 1, 2022 (EP) 22182645.6

(51) Int. Cl. A23L 27/00; A23J 3/16; A23L 27/20; A23L 27/22; A23L 27/23; A23L 27/24; A23L 27/26; A23L 27/30; A23L 31/15

(52) U.S. Cl. CPC A23L 27/88; A23J 3/16; A23L 27/204; A23L 27/2052; A23L 27/22; A23L 27/23; A23L 27/25; A23L 27/26; A23L 27/36; A23L 31/15

(57) ABSTRACT

The present disclosure generally relates to combinations of certain taste-modifying compounds with the compound: N-(heptan-4-yl)benzo[d][1,3]dioxole-5-carboxamide, which is also referred to herein a “TM1” and comestibly acceptable salts thereof. In some aspects, the disclosure provides compositions that include TM1, or a comestibly acceptable salt thereof, in combination with one or more umami or kokumi tastants. In some embodiments, the compositions are ingestible compositions, including, but not limited to, packaged food and beverage products.

### TECHNICAL FIELD

The present disclosure generally relates to combinations of certain taste-modifying compounds with the compound: N-(heptan-4-yl)benzo[d][1,3]dioxole-5-carboxamide, which is also referred to herein a “TM1” and comestibly acceptable salts thereof. In some aspects, the disclosure provides compositions that include TM1, or a comestibly acceptable salt thereof, in combination with one or more umami or kokumi tastants. In some embodiments, the compositions are ingestible compositions, including, but not limited to, packaged food and beverage products.

### DESCRIPTION OF RELATED ART

The taste system provides sensory information about the chemical composition of the external world. Taste transduction is one of the more sophisticated forms of chemically triggered sensation in animals. Signaling of taste is found throughout the animal kingdom, from simple metazoans to the most complex of vertebrates. Mammals are believed to have five basic taste modalities: sweet, bitter, sour, salty, and umami/kokumi.

Umami is the taste most commonly associated with the savory taste of monosodium glutamate (MSG), meat products, cheeses, tomatoes, mushrooms, soy sauce, fish sauce, miso, and the like. Mammals generally perceive umami to be a pleasurable sensation. Kokumi is a related taste commonly associated with the taste of fermented products, soy sauce, fish sauce, and shrimp paste. Many of these typical sources of umami and kokumi taste are high in glutamic acid and salt, or rely on animal products.

Excessive sodium intake can cause a number of health-related problems. One such problem is hypertension. Hypertension is a condition in which the pressure of the blood against artery walls is high enough that it may eventually cause heart disease and other health problems. Excessive sodium intake also adversely affect the balance of water and minerals in the body. For example, excessive sodium intake can cause calcium loss, which can lead to osteoporosis and other problems. Excessive consumption of food products containing glutamic acid can also have certain adverse health effects, as glutamic acid interferes with the functioning of neurotransmitters. Thus, it is generally desirable to reduce the consumption of sodium and glutamic acid. Further, there is increased consumer demand for food and beverage products that do not contain animal-derived ingredients, such as animal-derived fats, meat products, or dairy products.

Enhancement of umami or kokumi provides an alternative approach to partially or completely replacing ingredients that are traditionally used to impart umami or kokumi taste. Even so, formulating and using these compounds presents certain challenges. Thus, there is a continuing need to discover formulations and uses of umami- and kokumi-enhancing compounds in various food and beverage products.

### SUMMARY

The present disclosure relates to the discovery that certain taste-modifying compounds produce a satisfying umami or kokumi taste when used in combination with N-(heptan-4-yl)-benzo[d][1,3]dioxole-5-carboxamide, which is also referred to herein as “TM1” and which is represented by the chemical structure

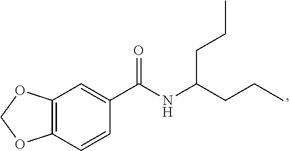 [SMILES: CCCC(CCC)NC(=O)c1ccc2c(c1)OCO2]

or comestibly acceptable salts thereof.

In a first aspect, the disclosure provides ingestible compositions comprising one or more 5′-ribonucleotides and N-(heptan-4-yl)benzo[d][1,3]dioxole-5-carboxamide. In some embodiments, the 5′-ribonucleotides are disodium 5′-ribonucleotides, such as disodium inosine monophosphate, disodium guanosine monophosphate, or any combination thereof. In some embodiments, the 5′ribonucleotides are derived from a yeast extract or an extract of other fermented products. In some embodiments, the ingestible composition further comprises a glutamate (such as monosodium glutamate), an aspartate, or a combination thereof. In some embodiments, the glutamate or aspartate is derived from a meat extract. In some embodiments, the ingestible composition comprises a hydrolyzed vegetable protein. In some embodiments, the glutamate or aspartate are derived from a yeast extract or an extract of other fermented products.

In a second aspect, the disclosure provides ingestible compositions comprising: (a) a yeast extract or a fermented product; and (b) N-(heptan-4-yl)benzo[d][1,3]dioxole-5-carboxamide. In some embodiments, the ingestible composition comprises a yeast extract. In some such embodiments, the yeast extract comprises one or more 5′-ribonucleotides, such as disodium inosine monophosphate, disodium guanosine monophosphate, or any combination thereof. In some embodiments, the ingestible composition further comprises a glutamate (such as monosodium glutamate), an aspartate, or a combination thereof. In some embodiments, the glutamate or aspartate is derived from a meat extract. In some embodiments, the glutamate or aspartate are derived from a yeast extract or an extract of other fermented products. In some embodiments, the ingestible composition comprises a hydrolyzed vegetable protein.

In a third aspect, the disclosure provides ingestible compositions comprising: (a) glucosylated steviol glycosides; (b) a flavonoid or a dihydrochalcone; and (c) N-(heptan-4-yl)benzo[d][1,3]dioxole-5-carboxamide. In some embodiments, the ingestible composition comprises a dihydrochalcone, such as neohesperidin dihydrochalcone, phloretin, and the like. In some embodiments, the ingestible composition comprises one or more 5′-ribonucleotides, such as disodium inosine monophosphate, disodium guanosine monophosphate, or any combination thereof. In some embodiments, the ingestible composition comprises a yeast extract or a fermented product. In some embodiments, the ingestible composition further comprises a glutamate (such as monosodium glutamate), an aspartate, or a combination thereof. In some embodiments, the glutamate or aspartate is derived from a meat extract. In some embodiments, the glutamate or aspartate are derived from a yeast extract or an extract of other fermented products. In some embodiments, the ingestible composition comprises a hydrolyzed vegetable protein.

In a fourth aspect, the disclosure provides ingestible compositions comprising: (a) a dipeptide, a tripeptide, or a combination thereof; and (b) N-(heptan-4-yl)benzo-[d][1,3]dioxole-5-carboxamide. In some embodiments, the ingestible composition comprises a tripeptide, such as γ-Glu-Val-Gly. In some embodiments, the ingestible composition comprises one or more 5′-ribonucleotides, such as disodium inosine monophosphate, disodium guanosine monophosphate, or any combination thereof. In some embodiments, the ingestible composition comprises a yeast extract or a fermented product. In some embodiments, the ingestible composition further comprises a glutamate (such as monosodium glutamate), an aspartate, or a combination thereof. In some embodiments, the glutamate or aspartate is derived from a meat extract. In some embodiments, the glutamate or aspartate are derived from a yeast extract or an extract of other fermented products. In some embodiments, the ingestible composition comprises a hydrolyzed vegetable protein.

In a fifth aspect, the disclosure provides ingestible compositions comprising: (a) N-acetylglutamic acid, N-acetylaspartic acid, or a combination thereof; and (b) N-(heptan-4-yl)benzo-[d][1,3]dioxole-5-carboxamide. In some embodiments, the ingestible composition comprises one or more 5′-ribonucleotides, such as disodium inosine monophosphate, disodium guanosine monophosphate, or any combination thereof. In some embodiments, the ingestible composition comprises a yeast extract or a fermented product. In some embodiments, the ingestible composition further comprises a glutamate (such as monosodium glutamate), an aspartate, or a combination thereof. In some embodiments, the glutamate or aspartate is derived from a meat extract. In some embodiments, the glutamate or aspartate are derived from a yeast extract or an extract of other fermented products. In some embodiments, the ingestible composition comprises a hydrolyzed vegetable protein.

In a sixth aspect, the disclosure provides ingestible compositions comprising: (a) (E)-3-(3,4-dimethoxyphenyl)-N-(4-methoxyphenethyl) acrylamide, 2-[3-(benzyloxy) propyl]-pyridine, (2E)-2-methyl-N-(4-{[(2E)-3-phenyl-2-propenoyl]amino}butyl)-2-butenamide, N-[(2E)-3,7-dimethyl-2,6-octadienyl]cyclopropylcarboxamide, (E)-N-(4-cinnamamidobutyl)-4-hydroxy-2-methylbut-2-enamide, rubenamine, rubescenamine, 1-(2-hydroxy-4-methoxyphenyl)-3-(2-pyridinyl)-1-propanone, or any combinations thereof; and (b) N-(heptan-4-yl)benzo-[d][1,3]dioxole-5-carboxamide. In some embodiments, the ingestible composition comprises one or more 5′-ribonucleotides, such as disodium inosine monophosphate, disodium guanosine monophosphate, or any combination thereof. In some embodiments, the ingestible composition comprises a yeast extract or a fermented product. In some embodiments, the ingestible composition further comprises a glutamate (such as monosodium glutamate), an aspartate, or a combination thereof. In some embodiments, the glutamate or aspartate is derived from a meat extract. In some embodiments, the glutamate or aspartate are derived from a yeast extract or an extract of other fermented products. In some embodiments, the ingestible composition comprises a hydrolyzed vegetable protein.

In a seventh aspect, the disclosure provides ingestible compositions comprising: (a) a 2-alkylpyridine; and (b) N-(heptan-4-yl)benzo-[d][1,3]dioxole-5-carboxamide. In some embodiments, the 2-alkylpyridine is 2-pentylpyridine, 2-hexylpyridine, or a combination thereof. In some embodiments, the ingestible composition comprises one or more 5′-ribonucleotides, such as disodium inosine monophosphate, disodium guanosine monophosphate, or any combination thereof. In some embodiments, the ingestible composition comprises a yeast extract or a fermented product. In some embodiments, the ingestible composition further comprises a glutamate (such as monosodium glutamate), an aspartate, or a combination thereof. In some embodiments, the glutamate or aspartate is derived from a meat extract. In some embodiments, the ingestible composition comprises a hydrolyzed vegetable protein.

In an eighth aspect, the disclosure provides a flavored product, which comprises an ingestible composition of any of the preceding aspects or embodiments thereof. In some embodiments, the flavored product is a beverage product. In some other embodiments, the flavored product is a food product, such as a soup, a broth, a meat analogue product, a savory flavoring packet, and the like.

Further aspects, and embodiments thereof, are set forth below in the Detailed Description, the Drawings, the Abstract, and the Claims.

### BRIEF DESCRIPTION OF THE DRAWINGS

The following drawings are provided for purposes of illustrating various embodiments of the compositions and methods disclosed herein. The drawings are provided for illustrative purposes only, and are not intended to describe any preferred compositions or preferred methods, or to serve as a source of any limitations on the scope of the claimed inventions.

FIG. 1 shows a chemical formula that represents the compound N-(heptan-4-yl)-benzo[d][1,3]dioxole-5-carboxamide.

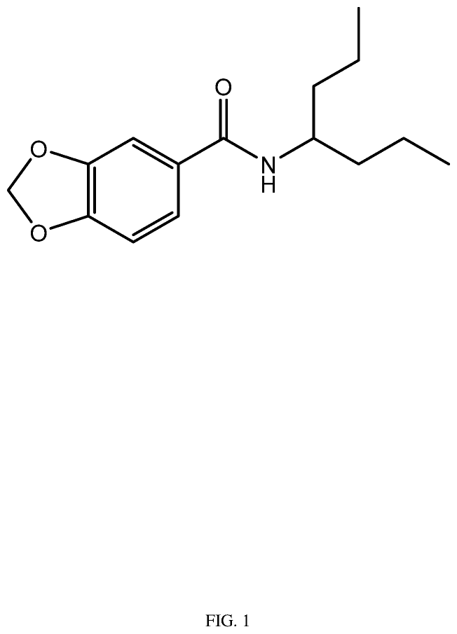

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary

A “sweetener”, “sweet flavoring agent”, “sweet flavor entity”, or “sweet compound” herein refers to a compound or ingestibly acceptable salt thereof that elicits a detectable sweet flavor in a subject, e.g., a compound that activates a T1R2/T1R3 receptor in vitro.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation and is not to be limited to an either/or construction. Thus, the phrase “comprising A or B” means that A can be present and not B, or that B is present and not A, or that A and B are both present. Further, if A, for example, defines a class that can have multiple members, e.g., A1 and A2, then one or more members of the class can be present concurrently.

Chemical structures are often shown using the “skeletal” format, such that carbon atoms are not explicitly shown, and hydrogen atoms attached to carbon atoms are omitted entirely. For example, the structure

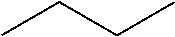

represents butane (i.e., n-butane). Furthermore, aromatic groups, such as benzene, are represented by showing one of the contributing resonance structures. For example, the structure

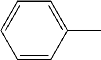

represents toluene.

Other terms are defined in other portions of this description, even though not included in this subsection.

### Ingestible Compositions

The present disclosure sets forth certain combinations of N-(heptan-4-yl)benzo[d][1,3]dioxole-5-carboxamide, otherwise referred to as “TM1”, and various other flavor-modifying components.

Combinations with 5-Ribunucleotides

In certain aspects, the disclosure provides ingestible compositions comprising: (a) one or more 5′-ribonucleotides; and (b) N-(heptan-4-yl)benzo[d][1,3]dioxole-5-carboxamide (TM1). The 5′-ribonucleotides and TM1 can be present in the ingestible composition in any suitable relative amounts. For example, in some embodiments, the weight ratio of the one or more 5′-ribonucleotides to TM1 in the ingestible composition ranges from 1:1 to 50:1, or from 2:1 to 20:1.

Any suitable 5′-ribonucleotides can be used. In general, the 5′-ribonucleotides are disodium salts of a 5′-ribonucleotide compound, such as disodium inosine monophosphate, disodium guanosine monophosphate, or any combination thereof. The 5′-ribonucleotides can be derived from any suitable source. For example, in some embodiments, the 5′-ribonucleotide compounds are present in the ingestible composition as isolated and purified compounds. In some other embodiments, the 5′-ribonucleotide compounds are present due to the inclusion of components that contain such compounds, such as yeast extracts or other fermented products.

In some embodiments, the ingestible composition comprises one or more additional ingredients, as set forth in greater detail below.

Combinations with Yeast Extracts or Fermented Products

In certain aspects, the disclosure provides ingestible compositions comprising: (a) a yeast extract or a fermented product; and (b) N-(heptan-4-yl)benzo[d][1,3]dioxole-5-carboxamide (TM1).

In some embodiments, the ingestible composition comprises a yeast extract. In some such embodiments, the yeast extract comprises one or more 5′-ribonucleotides, such as disodium inosine monophosphate, disodium guanosine monophosphate, or any combination thereof. The yeast extract and TM1 can be present in the ingestible composition in any suitable relative amounts. For example, in some embodiments, the weight ratio of the yeast extract to TM1 in the ingestible composition ranges from 2:1 to 100:1, or from 5:1 to 40:1. Any suitable yeast extracts can be used, such as those described in further detail below.

In some embodiments, the ingestible composition comprises a fermented product. Any suitable fermented product can be used, such as fermented vegetable products, fermented fruit products, alcoholic products, fermented soy products (such as miso or soy sauce), or fermented fish products (such as fish sauce). In some embodiments, the fermented product is a product rich in glutamate. In some embodiments, the fermented product is a product rich in 5′-ribunucleotides, such as disodium inosine monophosphate and disodium guanosine monophosphate. The fermented product and TM1 can be present in the ingestible composition in any suitable relative amounts. For example, in some embodiments, the dry weight ratio of the fermented product to TM1 in the ingestible composition ranges from 2:1 to 100:1, or from 5:1 to 40:1.

In some embodiments, the ingestible composition comprises one or more additional ingredients, as set forth in greater detail below.

Combinations with GSGs and Flavonoids or Dihydrochalcones

In certain aspects, the disclosure provides ingestible compositions comprising: (a) glucosylated steviol glycosides; (b) a flavonoid or a dihydrochalcone; and (c) N-(heptan-4-yl)benzo[d][1,3]dioxole-5-carboxamide (TM1).

Any suitable glucosylated steviol glycosides (GSGs) can be used. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth. The GSGs and TM1 can be present in the ingestible composition in any suitable relative amounts. For example, in some embodiments, the weight ratio of the GSGs to TM1 in the ingestible composition ranges from 1:50 to 50:1, or from 1:20 to 20:1.

In some embodiments, the ingestible composition comprises a dihydrochalcone. Any suitable dihydrochalcone can be used, including, but not limited to, neohesperidin dihydrochalcone, herperitin dihydrochalcone, phloretin, or any combination thereof. In some embodiments, the dihydrochalcone is neohesperidin dihydrochalcone. The dihydrochalcone and TM1 can be present in the ingestible composition in any suitable relative amounts. For example, in some embodiments, the weight ratio of the dihydrochalcone to TM1 in the ingestible composition ranges from 1:50 to 50:1, or from 1:20 to 20:1.

In some embodiments, the ingestible composition comprises a flavonoid. Any suitable flavonoid can be used, including, but not limited to, quercetin, hesperitin, naringenin, eriodictyol, homoeriodictyol, taxifolin, or any combination thereof. The flavonoid and TM1 can be present in the ingestible composition in any suitable relative amounts. For example, in some embodiments, the weight ratio of the flavonoid to TM1 in the ingestible composition ranges from 1:50 to 50:1, or from 1:20 to 20:1.

In some embodiments, the ingestible composition comprises one or more additional ingredients, as set forth in greater detail below.

Combinations with Dipeptides or Tripeptides

In certain aspects, the disclosure provides ingestible compositions comprising: (a) a dipeptide, a tripeptide, or a combination thereof; and (b) N-(heptan-4-yl)benzo-[d][1,3]dioxole-5-carboxamide (TM1).

Any suitable dipeptide or tripeptide or combination thereof can be used. For example, in some embodiments, the dipeptide or tripeptide is a γ-glutamyl-containing dipeptide or tripeptide, such as γ-Glu-Val-Gly. The dipeptides or tripeptides and TM1 can be present in the ingestible composition in any suitable relative amounts. For example, in some embodiments, the weight ratio of the dipeptides or tripeptides to TM1 in the ingestible composition ranges from 1:1 to 50:1, or from 2:1 to 20:1.

In some embodiments, the ingestible composition comprises one or more additional ingredients, as set forth in greater detail below.

Combinations with Amino Acids or N-acetyl Amino Acids

In certain aspects, the disclosure provides ingestible compositions comprising: (a) N-acetyl amino acids; and (b) N-(heptan-4-yl)benzo-[d][1,3]dioxole-5-carboxamide (TM1). Any suitable N-acetyl amino acids can be used, such as N-acetylglutamic acid, N-acetylaspartic acid, or a combination thereof. The N-acetyl amino acids and TM1 can be present in the ingestible composition in any suitable relative amounts. For example, in some embodiments, the weight ratio of the N-acetyl amino acids to TM1 in the ingestible composition ranges from 1:1 to 50:1, or from 2:1 to 20:1.

In certain aspects, the disclosure provides ingestible compositions comprising: (a) one or more amino acids; and (b) N-(heptan-4-yl)benzo-[d][1,3]dioxole-5-carboxamide (TM1). Any suitable amino acids can be used, such as glutamic acid, aspartic acid, or a combination thereof. In some embodiments, the one or more amino acids is glutamic acid. The amino acids and TM1 can be present in the ingestible composition in any suitable relative amounts. For example, in some embodiments, the weight ratio of the amino acids to TM1 in the ingestible composition ranges from 1:1 to 50:1, or from 2:1 to 20:1.

In some embodiments, the ingestible composition comprises one or more additional ingredients, as set forth in greater detail below.

Combinations with Umami-Enhancing Compounds

In certain aspects, the disclosure provides ingestible compositions comprising: (a) an umami-enhancing compound, which is (E)-3-(3,4-dimethoxyphenyl)-N-(4-methoxyphenethyl) acrylamide, 2-[3-(benzyloxy) propyl]-pyridine, (2E)-2-methyl-N-(4-{[(2E)-3-phenyl-2-propenoyl]amino}butyl)-2-butenamide, N-[(2E)-3,7-dimethyl-2,6-octadienyl]cyclopropylcarboxamide, (E)-N-(4-cinnamamidobutyl)-4-hydroxy-2-methylbut-2-enamidet, rubenamine, rubescenamine, 1-(2-hydroxy-4-methoxyphenyl)-3-(2-pyridinyl)-1-propanone, or any combinations thereof; and (b) N-(heptan-4-yl)benzo-[d][1,3]dioxole-5-carboxamide (TM1). In some embodiments, the umami-enhancing compound is (E)-3-(3,4-dimethoxyphenyl)-N-(4-methoxyphenethyl) acrylamide. In some embodiments, the umami-enhancing compound is 2-[3-(benzyloxy) propyl]-pyridine. In some embodiments, the umami-enhancing compound is (2E)-2-methyl-N-(4-{[(2E)-3-phenyl-2-propenoyl]amino}butyl)-2-butenamide. In some embodiments, the umami-enhancing compound is N-[(2E)-3,7-dimethyl-2,6-octadienyl]cyclopropyl-carboxamide. In some embodiments, the umami-enhancing compound is (E)-N-(4-cinnamamidobutyl)-4-hydroxy-2-methylbut-2-enamide. In some embodiments, the umami-enhancing compound is rubenamine. In some embodiments, the umami-enhancing compound is rubescenamine. In some embodiments, the umami-enhancing compound is 1-(2-hydroxy-4-methoxyphenyl)-3-(2-pyridinyl)-1-propanone. The umami-enhancing compound and TM1 can be present in the ingestible composition in any suitable relative amounts. For example, in some embodiments, the weight ratio of the umami-enhancing compound to TM1 in the ingestible composition ranges from 1:50 to 50:1, or from 1:20 to 20:1.

In some embodiments, the ingestible composition comprises one or more additional ingredients, as set forth in greater detail below.

Combinations with 2-Alkylpyridines

In certain aspects, the disclosure provides ingestible compositions comprising: (a) a 2-alkylpyridine; and (b) N-(heptan-4-yl)benzo-[d][1,3]dioxole-5-carboxamide. Any suitable 2-alkylpyridine can be used. For example, in some embodiments, the 2-alkylpyridine is 2-pentylpyridine, 2-hexylpyridine, or a combination thereof. The 2-alkylpyridine and TM1 can be present in the ingestible composition in any suitable relative amounts. For example, in some embodiments, the weight ratio of the 2-alkylpyridine to TM1 in the ingestible composition ranges from 1:50 to 50:1, or from 1:20 to 20:1.

In some embodiments, the ingestible composition comprises one or more additional ingredients, as set forth in greater detail below.

### Further Features of the Ingestible Compositions

To the extent that the compounds or ingredients listed below are not otherwise included in the ingestible compositions set forth above, these additional ingredients can be included in any of the ingestible compositions of the preceding aspects and embodiments.

In the various aspects set forth above, TM1 can have any suitable concentration in the ingestible composition. For example, in some embodiments, the concentration of TM1 in the ingestible composition ranges from 0.1 ppm to 1000 ppm, or from 0.1 ppm to 900 ppm, or from 0.1 ppm to 800 ppm, or from 0.1 ppm to 700 ppm, or from 0.1 ppm to 600 ppm, or from 0.1 ppm to 500 ppm, or from 0.1 ppm to 400 ppm, or from 0.1 ppm to 300 ppm, or from 0.1 ppm to 200 ppm, or from 0.1 ppm to 100 ppm, or from 0.1 ppm to 50 ppm, or from 0.1 ppm to 25 ppm, or from 0.1 ppm to 10 ppm, or from 1 ppm to 1000 ppm, or from 1 ppm to 900 ppm, or from 1 ppm to 800 ppm, or from 1 ppm to 700 ppm, or from 1 ppm to 600 ppm, or from 1 ppm to 500 ppm, or from 1 ppm to 400 ppm, or from 1 ppm to 300 ppm, or from 1 ppm to 200 ppm, or from 1 ppm to 100 ppm, or from 1 ppm to 50 ppm, or from 1 ppm to 25 ppm, or from 1 ppm to 10 ppm. Such ingestible compositions can be in any suitable form. In some embodiments, the ingestible composition is a food product, such as any of those specifically listed below. In other embodiments, the ingestible composition is a beverage product, such as a soda, and the like.

In some embodiments, the ingestible compositions comprise one or more bitter tastants, whose taste can be offset by the savory taste of TM1 when used in the combinations set forth above. The bitter compounds include, but are not limited to, active pharmaceutical ingredients (APIs), tannins (such as those in coffee, tea, or wine), ginseng, vitamins, minerals, limonin or nomelin (such as found in citrus juices), caffeine, quinine, catechins, polyphenols, potassium chloride, menthol, or plant starches or proteins (such as pea protein, soy protein, bean proteins, or potato protein), algal proteins or starches, fungal proteins or starches, or alcohol.

In certain embodiments of any aspects and embodiments set forth herein that refer to an ingestible composition, the ingestible composition is a non-naturally-occurring product, such as a composition specifically manufactured for the production of a flavored product, such as food or beverage product.

In some embodiments, the ingestible composition comprises one or more sweeteners. The sweetener can be present in the ingestible composition in any suitable concentration. For example, in some embodiments, the sweetener is present in an amount from about 0.1% to about 12% by weight. In some embodiments, the sweetener is present in an amount from about 0.2% to about 10% by weight. In some embodiments, the sweetener is present in an amount from about 0.3% to about 8% by weight. In some embodiments, the sweetener is present in an amount from about 0.4% to about 6% by weight. In some embodiments, the sweetener is present in an amount from about 0.5% to about 5% by weight. In some embodiments, the sweetener is present in an amount from about 1% to about 2% by weight. In some embodiments, the sweetener is present in an amount from about 0.1% to about 5% by weight. In some embodiments, the sweetener is present in an amount from about 0.1% to about 4% by weight. In some embodiments, the sweetener is present in an amount from about 0.1% to about 3% by weight. In some embodiments, the sweetener is present in an amount from about 0.1% to about 2% by weight. In some embodiments, the sweetener is present in an amount from about 0.1% to about 1% by weight. In some embodiments, the sweetener is present in an amount from about 0.1% to about 0.5% by weight. In some embodiments, the sweetener is present in an amount from about 0.5% to about 10% by weight. In some embodiments, the sweetener is present in an amount from about 2% to about 8% by weight. In some further embodiments of the embodiments set forth in this paragraph, the sweetener is sucrose, fructose, glucose, xylitol, erythritol, or combinations thereof.

In some other embodiments, lower concentrations of sweetener may be more appropriate. For example, in some embodiments, the sweetener is present in the ingestible composition in an amount from 10 ppm to 1000 ppm. In some embodiments, the sweetener is present in an amount from 20 ppm to 800 ppm. In some embodiments, the sweetener is present in an amount from 30 ppm to 600 ppm. In some embodiments, the sweetener is present in an amount from 40 ppm to 500 ppm. In some embodiments, the sweetener is present in an amount from 50 ppm to 400 ppm. In some embodiments, the sweetener is present in an amount from 50 ppm to 300 ppm. In some embodiments, the sweetener is present in an amount from 50 ppm to 200 ppm. In some embodiments, the sweetener is present in an amount from 50 ppm to 150 ppm. In some further embodiments of the embodiments set forth in this paragraph, the sweetener is a steviol glycoside, a mogroside, a derivative of either of the foregoing, such as glycoside derivatives (e.g., glucosylates), or any combination thereof.

The ingestible compositions can include any suitable sweeteners or combination of sweeteners. In some embodiments, the sweetener is a common saccharide sweeteners, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the sweetener is a combination of two or more of the sweeteners set forth in this paragraph. In some embodiments, the sweetener may combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar may be sucrose. In some embodiments, the sugar may be a combination of fructose and glucose.

The sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

In still other embodiments, the sweetener can be a chemically or enzymatically modified natural high potency sweetener. Modified natural high potency sweeteners include glycosylated natural high potency sweetener such as glucosyl-, galactosyl-, or fructosyl-derivatives containing 1-50 glycosidic residues. Glycosylated natural high potency sweeteners may be prepared by enzymatic transglycosylation reaction catalyzed by various enzymes possessing transglycosylating activity. In some embodiments, the modified sweetener can be substituted or unsubstituted.

The ingestible compositions can, in certain embodiments, comprise any additional ingredients or combination of ingredients as are commonly used in food and beverage products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);
coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins or functional ingredients including, for example resveratrol, Co-Q10, omega 3 fatty acids, theanine, choline chloride (citocoline), fibersol, inulin (chicory root), taurine, Panax ginseng extract, guanana extract, ginger extract, L-phenylalanine, L-carnitine, L-tartrate, D-glucoronolactone, inositol, bioflavonoids, Echinacea, ginko biloba, yerba mate, flax seed oil, garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;
clouding agents, including, for example ester gun, brominated vegetable oil (BVO), or sucrose acetate isobutyrate (SAIB);
buffers, including, for example sodium citrate, potassium citrate, or salt;
flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; or
starches and stabilizers, including, for example pectin, xanthan gum, carboxylmethylcellulose (CMC), polysorbate 60, polysorbate 80, medium chain triglycerides, cellulose gel, cellulose gum, sodium caseinate, modified food starch, gum Arabic (gum acacia), inulin, or carrageenan.

The ingestible compositions or sweetener concentrates can have any suitable pH. In some embodiments, the flavor-modifying compounds enhance the sweetness of a sweetener under a broad range of pH, e.g., from lower pH to neutral pH. The lower and neutral pH includes, but is not limited to, a pH from 1.5 to 9.0, or from 2.5 to 8.5; from 3.0 to 8.0; from 3.5 to 7.5; and from 4.0 to 7. In certain embodiments, compounds as disclosed and described herein, individually or in combination, can enhance the perceived sweetness of a fixed concentration of a sweetener in taste tests at a compound concentration of 50 μM, 40 μM, 30 μM, 20 μM, or 10 μM at both low to neutral pH value. In certain embodiments, the enhancement factor of the compounds as disclosed and described herein, individually or in combination, at the lower pH is substantially similar to the enhancement factor of the compounds at neutral pH. Such consistent sweet enhancing property under a broad range of pH allow a broad use in a wide variety of foods and beverages of the compounds as disclosed and described herein, individually or in combination.

In some embodiments, ingestible compositions disclosed herein comprise one or more umami or kokumi tastants. Such umami or kokumi tastants include, but are not limited to, N¹-(2,4-dimethoxybenzyl)-N²-(2-(pyridin-2-yl)ethyl) oxalamide, alkyl amides, glutamates (such as monosodium glutamate (MSG)), arginates, purinic ribotides (such as inosine monophosphate (IMP), adenosine monophosphate (AMP), guanosine monophosphate (GMP), and sodium salts thereof), amino acids (such as L-threanine), oligopeptides (such as glutamyl oligopeptides), cheeses and cheese extracts, yeast extracts, hydrolyzed vegetable protein, and alcohol. TM1 may be used in combination with such umami or kokumi tastants in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In some embodiments, the ingestible compositions comprise a yeast extract, such as a yeast lysate. Such extracts can be obtained from any suitable yeast strain, where such extracts are suitable for human consumption. Non-limiting examples of such yeasts include: yeasts of the genus Saccharomyces, such as Saccharomyces cerevisiae or Saccharomyces pastorianus; yeasts of the genus Candida, such as Candida utilis; yeasts of the genus Kluyveromyces, such as Kluyveromyces lactis or Kluyveromyces marxianus; yeasts of the genus Pichia such as Pichia pastoris; yeasts of the genus Debaryomyces such as Debaryomyces hansenii; and yeasts of the genus Zygosaccharomyces such as Zygosaccharomyces mellis. In some embodiments, the yeast is a yeast collected after brewing beer, sake, or the like. In some embodiments, the yeast is a yeast subjected to drying treatment (dried yeast) after collection.

Such extracts can be produced by any suitable means. In general, yeast extracts or lysates are made by extracting the contents of the yeast cells from the cell wall material. In many instances, the digestive enzymes in the cells (or additional enzymes added to the composition) break down the proteins and polynucleotides in the yeast to amino acids, oligopeptides (for example, from 2 to 10 peptides), nucleotides, oligonucleotides (from 2 to 10 nucleotides), and mixtures thereof. A yeast lysate can be prepared by lysing a yeast. For example, in some embodiments, the yeast after culture is crushed or lysed by an enzymatic decomposition method, a self-digestion method, an alkaline extraction method, a hot water extraction method, an acid decomposition method, an ultrasonic crushing method, crushing with a homogenizer, a freezing-thawing method, or the like (two or more thereof may be used in combination), whereby a yeast lysate is obtained. Yeast may be cultured by a conventional method. In some embodiments, the yeast after culture is heat-treated and then treated with a lytic enzyme to obtain an enzyme lysate. The conditions for the heat treatment are, for example, 80° C. to 90° C. for 5 minutes to 30 minutes. As the lytic enzyme used for the enzymatic decomposition method, various enzymes can be used as long as they can lyse the cell wall of yeast. The reaction conditions may be set so as to be optimum or suitable for the lytic enzyme(s) to be used, and specific examples thereof can include a temperature of 50° C. to 60° C., and a pH of 7.0 to 8.0. The reaction time is also not particularly limited, and can be, for example, 3 hours to 5 hours.

Compositions comprising yeast lysate can be obtained from a variety of commercial sources. For example, in some embodiments, the yeast lysate is provides by the flavoring additive sold under the name MODUMAX (DSM Food Specialties BV, Delft, Netherlands).

In some embodiments, ingestible compositions disclosed herein comprise one or more bitter tastants. Such bitter tastants include, but are not limited to, active pharmaceutical ingredients (APIs), tannins (such as those in coffee, tea, or wine), ginseng, vitamins, minerals, limonin or nomelin (such as found in citrus juices), caffeine, quinine, catechins, polyphenols, potassium chloride, menthol, other commonly used oral care ingredients, cooling agents (such as N-ethyl-N-(thiophen-2-ylmethyl)-2-(p-tolyloxy) acetamide, N-(1H-pyrazol-3-yl)-N-(thiophen-2-ylmethyl)-2-(p-tolyloxy) acetamide, 2-(4-fluorophenoxy)-N-(1H-pyrazol-3-yl)-N-(thiophen-2-ylmethyl) acetamide, 2-(2-hydroxy-4-methylphenoxy)-N-(1H-pyrazol-3-yl)-N-(thiophen-2-ylmethyl)-acetamide, 2-((2,3-dihydro-1H-inden-5-yl)oxy)-N-(1H-pyrazol-3-yl)-N-(thiophen-2-ylmethyl)-acetamide, 2-((2,3-dihydro-1H-inden-5-yl)oxy)-N-(1H-pyrazol-3-yl)-N-(thiazol-5-ylmethyl)-acetamide, and 2-((5-methoxybenzofuran-2-yl)oxy)-N-(1H-pyrazol-3-yl)-N-(thiophen-2-ylmethyl)-acetamide), plant starches or proteins (such as pea protein, soy protein, chickpea protein, bean protein, or potato protein), algal proteins or starches, fungal proteins or starches, or alcohol, high-intensity sweeteners, such as saccharin, steviol glycosides, mogrosides, aspartame, and the like. The unsaturated fatty acid compound may be used in combination with such bitter tastants in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

The ingestible compositions set forth according to any of the foregoing embodiments, also include, in certain embodiments, one or more additional flavor-modifying compounds, such as compounds that enhance sweetness (e.g., hesperetin, naringenin, glucosylated steviol glycosides, etc.), compounds that block bitterness, compounds that enhance umami, compounds that reduce sourness or licorice taste, compounds that enhance saltiness, compounds that enhance a cooling effect, or any combinations of the foregoing.

Thus, in some embodiments, ingestible compositions disclosed herein comprise TM1 and one or more sweetness enhancing compounds. Such sweetness enhancing compounds include, but are not limited to, 3-((4-amino-2,2-dioxo-1H-benzo[c][1,2,6]thiadiazin-5-yl)oxy)-2,2-dimethyl-N-propyl-propanamide, N-(1-((4-amino-2,2-dioxo-1H-benzo[c][1,2,6]thiadiazin-5-yl)oxy)-2-methyl-propan-2-yl) isonicotinamide, 4-amino-5,6-dimethylthieno[2,3-d]pyrimidin-2 (1H)-one, hesperitin dihydrochalcone, hesperitin dihydrochalcone-4′-O′glucoside, neohesperitin dihydrochalcone, naringenin, naringin, phloretin, glucosylated steviol glycosides, trilobatin, eriodictyol, homoeriodictyol, brazzein, (2R,3R)-3-acetoxy-5,7,4′-trihydroxyflavanone, (2R,3R)-3-acetoxy-5,7,3′-trihydroxy-4′-methoxyflavanone, rubusosides, or compounds such as those set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. The TM1 may be used in combination with such other sweetness enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1. In some embodiments of any of the preceding embodiments, the unsaturated fatty acid compound is combined with glucosylated steviol glycosides in any of the above ratios.

In some further embodiments, ingestible compositions disclosed herein comprise one or more umami or kokumi enhancing compounds. Such umami enhancing compounds include, but are not limited to, naturally derived compounds, such as (E)-3-(3,4-dimethoxyphenyl)-N-(4-methoxyphenethyl)-acrylamide, or synthetic compounds, such as N¹-(2,4-dimethoxybenzyl)-N²-(2-(pyridin-2-yl)ethyl)-oxalamide, alkyl amides, or any other compounds set forth in U.S. Pat. Nos. 8,735,081; 8,124,121; and 8,968,708. TM1 may be used in combination with such umami enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In some further embodiments, ingestible compositions disclosed herein comprise the unsaturated fatty acid compound combined with one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727.

In some further embodiments, ingestible compositions disclosed herein comprise one or more other bitterness blocking compounds. Such bitterness blocking compounds include, but are not limited to 3-(1-((3,5-dimethylisoxazol-4-yl)methyl)-1H-pyrazol-4-yl)-1-(3-hydroxybenzyl)-imidazolidine-2,4-dione, N-(7-acetyl-2,3-dihydrobenzo-[b][1,4]dioxin-6-yl)-2-(4-acetylpiperazin-1-yl) acetamide, or other compounds set forth in U.S. Pat. Nos. 8,076,491; 8,445,692; and 9,247,759, or in PCT Publication No. WO 2020/033669. The unsaturated fatty acid compound may be used in combination with such bitterness blockers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In some further embodiments, ingestible compositions disclosed herein comprise one or more sour taste modulating compounds. The unsaturated fatty acid compound may be used in combination with such sour taste modulating compounds in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In some further embodiments, ingestible compositions disclosed herein comprise one or more mouthfeel modifying compounds. Such mouthfeel modifying compounds include, but are not limited to, tannins, cellulosic materials, bamboo powder, and the like. The unsaturated fatty acid compound may be used in combination with such mouthfeel enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In some further embodiments, ingestible compositions disclosed herein comprise one or more flavor masking compounds. Such flavor masking compounds include, but are not limited to, cellulosic materials, materials extracted from fungus, materials extracted from plants, citric acid, carbonic acid (or carbonates), and the like. The unsaturated fatty acid compound may be used in combination with such mouthfeel enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In certain embodiments, the ingestible composition comprises a non-animal protein, such as a plant protein, an algal protein, or a mycoprotein. In some embodiments, the comestible composition comprises a plant-based protein. Non-limiting examples of plant proteins include pea protein, soy protein, almond protein, cashew protein, canola (rapeseed) protein, chickpea protein, fava protein, sunflower protein, wheat protein, oat protein, and potato protein. The non-animal proteins can make up any suitable proportion of the comestible composition. For example, in some embodiments, the non-animal protein makes up from 5 percent by weight to 50 percent by weight, or from 5 percent by weight to 40 percent by weight, or from 5 percent by weight to 30 percent by weight, or from 5 percent by weight to 20 percent by weight, of the ingestible composition, based on the total weight of the ingestible composition.

In some embodiments, the ingestible composition comprises certain fibers, such as insoluble fibers, that can provide structure and texture to the ingestible composition. Any suitable insoluble fiber can be used. In some embodiments, the insoluble fiber is a plant-derived fiber. Non-limiting examples include nut fibers, grain fibers, rice fibers, seed fibers, oat fibers, pea fibers, potato fibers, berry fibers, soybean fibers, banana fibers, citrus fibers, apple fibers, and carrot fibers. In some embodiments, the insoluble fiber is pea fiber. The insoluble fiber can make up any suitable proportion of the comestible composition. For example, in some embodiments, the soluble fiber makes up from 5 percent by weight to 50 percent by weight, or from 5 percent by weight to 40 percent by weight, or from 5 percent by weight to 30 percent by weight, or from 5 percent by weight to 20 percent by weight, of the ingestible composition, based on the total weight of the ingestible composition.

In some aspects related to the preceding aspects and embodiments, the disclosure provides uses of the ingestible compositions disclosed herein to enhance the flavor of a flavored composition, such as a flavored article. Such flavored compositions can use any suitable flavors, such as fruit flavors, meat flavors, vegetable flavors, and the like. In some embodiments, the flavored composition is a soup or broth, or a chip, or a beverage.

### Flavored Products

In certain aspects, the disclosure provides flavored products comprising any ingestible compositions of the preceding aspects. In some embodiments, the flavored products are beverage products, such as soda, flavored water, tea, and the like. In some other embodiments, the flavored products are food products, such as yogurt.

In embodiments where the flavored product is a beverage, the beverage may be selected from the group consisting of enhanced sparkling beverages, colas, lemon-lime flavored sparkling beverages, orange flavored sparkling beverages, grape flavored sparkling beverages, strawberry flavored sparkling beverages, pineapple flavored sparkling beverages, ginger-ales, root beers, fruit juices, fruit-flavored juices, juice drinks, nectars, vegetable juices, vegetable-flavored juices, sports drinks, energy drinks, enhanced water drinks, enhanced water with vitamins, near water drinks, coconut waters, tea type drinks, coffees, cocoa drinks, beverages containing milk components, beverages containing cereal extracts and smoothies. In some embodiments, the beverage may be a soft drink.

In certain embodiments of any aspects and embodiments set forth herein that refer to an flavored product, the flavored product is a non-naturally-occurring product, such as a packaged food or beverage product.

Further non-limiting examples of food and beverage products or formulations include sweet coatings, frostings, or glazes for such products or any entity included in the Soup category, the Dried Processed Food category, the Beverage category, the Ready Meal category, the Canned or Preserved Food category, the Frozen Processed Food category, the Chilled Processed Food category, the Snack Food category, the Baked Goods category, the Confectionery category, the Dairy Product category, the Ice Cream category, the Meal Replacement category, the Pasta and Noodle category, and the Sauces, Dressings, Condiments category, the Baby Food category, and/or the Spreads category.

In general, the Soup category refers to canned/preserved, dehydrated, instant, chilled, UHT and frozen soup. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups).

The Dehydrated and Culinary Food Category usually means: (i) Cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); (ii) Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; and (iii) Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.

The Beverage category usually means beverages, beverage mixes and concentrates, including but not limited to, carbonated and non-carbonated beverages, alcoholic and non-alcoholic beverages, ready to drink beverages, liquid concentrate formulations for preparing beverages such as sodas, and dry powdered beverage precursor mixes. The Beverage category also includes the alcoholic drinks, the soft drinks, sports drinks, isotonic beverages, and hot drinks. The alcoholic drinks include, but are not limited to beer, cider/perry, FABs, wine, and spirits. The soft drinks include, but are not limited to carbonates, such as colas and non-cola carbonates; fruit juice, such as juice, nectars, juice drinks and fruit flavored drinks; bottled water, which includes sparkling water, spring water and purified/table water; functional drinks, which can be carbonated or still and include sport, energy or elixir drinks; concentrates, such as liquid and powder concentrates in ready to drink measure. The drinks, either hot or cold, include, but are not limited to coffee or ice coffee, such as fresh, instant, and combined coffee; tea or ice tea, such as black, green, white, oolong, and flavored tea; and other drinks including flavor-, malt- or plant-based powders, granules, blocks or tablets mixed with milk or water.

The Snack Food category generally refers to any food that can be a light informal meal including, but not limited to Sweet and savory snacks and snack bars. Examples of snack food include, but are not limited to fruit snacks, chips/crisps, extruded snacks, tortilla/corn chips, popcorn, pretzels, nuts and other sweet and savory snacks. Examples of snack bars include, but are not limited to granola/muesli bars, breakfast bars, energy bars, fruit bars and other snack bars.

The Baked Goods category generally refers to any edible product the process of preparing which involves exposure to heat or excessive sunlight. Examples of baked goods include, but are not limited to bread, buns, cookies, muffins, cereal, toaster pastries, pastries, waffles, tortillas, biscuits, pies, bagels, tarts, quiches, cake, any baked foods, and any combination thereof.

The Ice Cream category generally refers to frozen dessert containing cream and sugar and flavoring. Examples of ice cream include, but are not limited to: impulse ice cream; take-home ice cream; frozen yoghurt and artisanal ice cream; soy, oat, bean (e.g., red bean and mung bean), and rice-based ice creams.

The Confectionery category generally refers to edible product that is sweet to the taste. Examples of confectionery include, but are not limited to candies, gelatins, chocolate confectionery, sugar confectionery, gum, and the likes and any combination products.

The Meal Replacement category generally refers to any food intended to replace the normal meals, particularly for people having health or fitness concerns. Examples of meal replacement include, but are not limited to slimming products and convalescence products.

The Ready Meal category generally refers to any food that can be served as meal without extensive preparation or processing. The ready meal includes products that have had recipe “skills” added to them by the manufacturer, resulting in a high degree of readiness, completion and convenience. Examples of ready meal include, but are not limited to canned/preserved, frozen, dried, chilled ready meals; dinner mixes; frozen pizza; chilled pizza; and prepared salads.

The Pasta and Noodle category includes any pastas and/or noodles including, but not limited to canned, dried and chilled/fresh pasta; and plain, instant, chilled, frozen and snack noodles.

The Canned/Preserved Food category includes, but is not limited to canned/preserved meat and meat products, fish/seafood, vegetables, tomatoes, beans, fruit, ready meals, soup, pasta, and other canned/preserved foods.

The Frozen Processed Food category includes, but is not limited to frozen processed red meat, processed poultry, processed fish/seafood, processed vegetables, meat substitutes, processed potatoes, bakery products, desserts, ready meals, pizza, soup, noodles, and other frozen food.

The Dried Processed Food category includes, but is not limited to rice, dessert mixes, dried ready meals, dehydrated soup, instant soup, dried pasta, plain noodles, and instant noodles. The Chill Processed Food category includes, but is not limited to chilled processed meats, processed fish/seafood products, lunch kits, fresh cut fruits, ready meals, pizza, prepared salads, soup, fresh pasta and noodles.

The Sauces, Dressings and Condiments category includes, but is not limited to tomato pastes and purees, bouillon/stock cubes, herbs and spices, monosodium glutamate (MSG), table sauces, soy based sauces, pasta sauces, wet/cooking sauces, dry sauces/powder mixes, ketchup, mayonnaise, mustard, salad dressings, vinaigrettes, dips, pickled products, and other sauces, dressings and condiments.

The Baby Food category includes, but is not limited to milk- or soybean-based formula; and prepared, dried and other baby food.

The Spreads category includes, but is not limited to jams and preserves, honey, chocolate spreads, nut based spreads, and yeast based spreads.

The Dairy Product category generally refers to edible product produced from mammal's milk. Examples of dairy product include, but are not limited to drinking milk products, cheese, yoghurt and sour milk drinks, and other dairy products.

Additional examples for flavored products, particularly food and beverage products or formulations, are provided as follows. Exemplary ingestible compositions include one or more confectioneries, chocolate confectionery, tablets, countlines, bagged selflines/softlines, boxed assortments, standard boxed assortments, twist wrapped miniatures, seasonal chocolate, chocolate with toys, alfajores, other chocolate confectionery, mints, standard mints, power mints, boiled sweets, pastilles, gums, jellies and chews, toffees, caramels and nougat, medicated confectionery, lollipops, liquorice, other sugar confectionery, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savory biscuits and crackers, bread substitutes, breakfast cereals, rte cereals, family breakfast cereals, flakes, muesli, other cereals, children's breakfast cereals, hot cereals, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavored, functional and other condensed milk, flavored milk drinks, dairy only flavored milk drinks, flavored milk drinks with fruit juice, soy milk, sour milk drinks, fermented dairy drinks, coffee whiteners, powder milk, flavored powder milk drinks, cream, cheese, processed cheese, spreadable processed cheese, unspreadable processed cheese, unprocessed cheese, spreadable unprocessed cheese, hard cheese, packaged hard cheese, unpackaged hard cheese, yoghurt, plain/natural yoghurt, flavored yoghurt, fruited yoghurt, probiotic yoghurt, drinking yoghurt, regular drinking yoghurt, probiotic drinking yoghurt, chilled and shelf-stable desserts, dairy-based desserts, soy-based desserts, chilled snacks, fromage frais and quark, plain fromage frais and quark, flavored fromage frais and quark, savory fromage frais and quark, sweet and savory snacks, fruit snacks, chips/crisps, extruded snacks, tortilla/corn chips, popcorn, pretzels, nuts, other sweet and savory snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, frozen pizza, chilled pizza, soup, canned soup, dehydrated soup, instant soup, chilled soup, hot soup, frozen soup, pasta, canned pasta, dried pasta, chilled/fresh pasta, noodles, plain noodles, instant noodles, cups/bowl instant noodles, pouch instant noodles, chilled noodles, snack noodles, canned food, canned meat and meat products, canned fish/seafood, canned vegetables, canned tomatoes, canned beans, canned fruit, canned ready meals, canned soup, canned pasta, other canned foods, frozen food, frozen processed red meat, frozen processed poultry, frozen processed fish/seafood, frozen processed vegetables, frozen meat substitutes, frozen potatoes, oven baked potato chips, other oven baked potato products, non-oven frozen potatoes, frozen bakery products, frozen desserts, frozen ready meals, frozen pizza, frozen soup, frozen noodles, other frozen food, dried food, dessert mixes, dried ready meals, dehydrated soup, instant soup, dried pasta, plain noodles, instant noodles, cups/bowl instant noodles, pouch instant noodles, chilled food, chilled processed meats, chilled fish/seafood products, chilled processed fish, chilled coated fish, chilled smoked fish, chilled lunch kit, chilled ready meals, chilled pizza, chilled soup, chilled/fresh pasta, chilled noodles, oils and fats, olive oil, vegetable and seed oil, cooking fats, butter, margarine, spreadable oils and fats, functional spreadable oils and fats, sauces, dressings and condiments, tomato pastes and purees, bouillon/stock cubes, stock cubes, gravy granules, liquid stocks and fonds, herbs and spices, fermented sauces, soy based sauces, pasta sauces, wet sauces, dry sauces/powder mixes, ketchup, mayonnaise, regular mayonnaise, mustard, salad dressings, regular salad dressings, low fat salad dressings, vinaigrettes, dips, pickled products, other sauces, dressings and condiments, baby food, milk formula, standard milk formula, follow-on milk formula, toddler milk formula, hypoallergenic milk formula, prepared baby food, dried baby food, other baby food, spreads, jams and preserves, honey, chocolate spreads, nut-based spreads, and yeast-based spreads. Exemplary ingestible compositions also include confectioneries, bakery products, ice creams, dairy products, sweet and savory snacks, snack bars, meal replacement products, ready meals, soups, pastas, noodles, canned foods, frozen foods, dried foods, chilled foods, oils and fats, baby foods, or spreads or a mixture thereof. Exemplary ingestible compositions also include breakfast cereals, sweet beverages or solid or liquid concentrate compositions for preparing beverages, ideally so as to enable the reduction in concentration of previously known saccharide sweeteners, or artificial sweeteners.

Some embodiments provide a chewable composition that may or may not be intended to be swallowed. In some embodiments, the chewable composition may be gum, chewing gum, sugarized gum, sugar-free gum, functional gum, bubble gum including compounds as disclosed and described herein, individually or in combination.

Typically at least a sweet receptor modulating amount, a sweet receptor ligand modulating amount, a sweet flavor modulating amount, a sweet flavoring agent amount, a sweet flavor enhancing amount, or a therapeutically effective amount of one or more of the present compounds will be added to the ingestible composition, optionally in the presence of sweeteners so that the sweet flavor modified ingestible composition has an increased sweet taste as compared to the ingestible composition prepared without the compounds of the present invention, as judged by human beings or animals in general, or in the case of formulations testing, as judged by a majority of a panel of at least eight human taste testers, via procedures commonly known in the field.

In some embodiments, compounds as disclosed and described herein, individually or in combination, modulate the sweet taste or other taste properties of other natural or synthetic sweet tastants, and ingestible compositions made therefrom. In one embodiment, the compounds as disclosed and described herein, individually or in combination, may be used or provided in its ligand enhancing concentration(s). For example, the compounds as disclosed and described herein, individually or in combination, may be present in an amount of from 0.001 ppm to 100 ppm, or narrower alternative ranges from 0.1 ppm to 50 ppm, from 0.01 ppm to 40 ppm, from 0.05 ppm to 30 ppm, from 0.01 ppm to 25 ppm, or from 0.1 ppm to 30 ppm, or from 0.1 ppm to 25 ppm, or from 1 ppm to 30 ppm, or from 1 ppm to 25 ppm.

In some embodiments, flavor-modifying compounds as disclosed and described herein, individually or in combination, may be provided in a flavoring concentrate formulation, e.g., suitable for subsequent processing to produce a ready-to-use (i.e., ready-to-serve) product. By “a flavoring concentrate formulation”, it is meant a formulation which should be reconstituted with one or more diluting medium to become a ready-to-use composition. The term “ready-to-use composition” is used herein interchangeably with “ingestible composition”, which denotes any substance that, either alone or together with another substance, can be taken by mouth whether intended for consumption or not. In one embodiment, the ready-to-use composition includes a composition that can be directly consumed by a human or animal. The flavoring concentrate formulation is typically used by mixing with or diluted by one or more diluting medium, e.g., any consumable or ingestible ingredient or product, to impart or modify one or more flavors to the diluting medium. Such a use process is often referred to as reconstitution. The reconstitution can be conducted in a household setting or an industrial setting. For example, a frozen fruit juice concentrate can be reconstituted with water or other aqueous medium by a consumer in a kitchen to obtain the ready-to-use fruit juice beverage. In another example, a soft drink syrup concentrate can be reconstituted with water or other aqueous medium by a manufacturer in large industrial scales to produce the ready-to-use soft drinks. Since the flavoring concentrate formulation has the flavoring agent or flavor modifying agent in a concentration higher than the ready-to-use composition, the flavoring concentrate formulation is typically not suitable for being consumed directly without reconstitution. There are many benefits of using and producing a flavoring concentrate formulation. For example, one benefit is the reduction in weight and volume for transportation as the flavoring concentrate formulation can be reconstituted at the time of usage by the addition of suitable solvent, solid or liquid.

The flavored products set forth according to any of the foregoing embodiments, also include, in certain embodiments, one or more additional flavor-modifying compounds, such as compounds that enhance sweetness (e.g., hesperetin, naringenin, glucosylated steviol glycosides, etc.), compounds that block bitterness, compounds that enhance umami, compounds that reduce sourness, compounds that enhance saltiness, compounds that enhance a cooling effect, or any combinations of the foregoing.

In certain embodiments of any aspects and embodiments set forth herein that refer to a sweetening or flavoring concentrate, the sweetening or flavoring concentrate is a non-naturally-occurring product, such as a composition specifically manufactured for the production of a flavored product, such as food or beverage product.

In one embodiment, the flavoring concentrate formulation comprises i) compounds as disclosed and described herein, individually or in combination; ii) a carrier; and iii) optionally at least one adjuvant. The term “carrier” denotes a usually inactive accessory substance, such as solvents, binders, or other inert medium, which is used in combination with the present compound and one or more optional adjuvants to form the formulation. For example, water or starch can be a carrier for a flavoring concentrate formulation. In some embodiments, the carrier is the same as the diluting medium for reconstituting the flavoring concentrate formulation; and in other embodiments, the carrier is different from the diluting medium. The term “carrier” as used herein includes, but is not limited to, ingestibly acceptable carrier.

The term “adjuvant” denotes an additive which supplements, stabilizes, maintains, or enhances the intended function or effectiveness of the active ingredient, such as the compound of the present invention. In one embodiment, the at least one adjuvant comprises one or more flavoring agents. The flavoring agent may be of any flavor known to one skilled in the art or consumers, such as the flavor of chocolate, coffee, tea, mocha, French vanilla, peanut butter, chai, or combinations thereof. In another embodiment, the at least one adjuvant comprises one or more sweeteners. The one or more sweeteners can be any of the sweeteners described in this application. In another embodiment, the at least one adjuvant comprises one or more ingredients selected from the group consisting of a emulsifier, a stabilizer, an antimicrobial preservative, an antioxidant, vitamins, minerals, fats, starches, protein concentrates and isolates, salts, and combinations thereof. Examples of emulsifiers, stabilizers, antimicrobial preservatives, antioxidants, vitamins, minerals, fats, starches, protein concentrates and isolates, and salts are described in U.S. Pat. No. 6,468,576, the content of which is hereby incorporated by reference in its entirety for all purposes.

In one embodiment, the present flavoring concentrate formulation can be in a form selected from the group consisting of liquid including solution and suspension, solid, foamy material, paste, gel, cream, and a combination thereof, such as a liquid containing certain amount of solid contents. In one embodiment, the flavoring concentrate formulation is in form of a liquid including aqueous-based and nonaqueous-based. In some embodiments, the present flavoring concentrate formulation can be carbonated or non-carbonated.

The flavoring concentrate formulation may further comprise a freezing point depressant, nucleating agent, or both as the at least one adjuvant. The freezing point depressant is an ingestibly acceptable compound or agent which can depress the freezing point of a liquid or solvent to which the compound or agent is added. That is, a liquid or solution containing the freezing point depressant has a lower freezing point than the liquid or solvent without the freezing point depressant. In addition to depress the onset freezing point, the freezing point depressant may also lower the water activity of the flavoring concentrate formulation. The examples of the freezing point depressant include, but are not limited to, carbohydrates, oils, ethyl alcohol, polyol, e.g., glycerol, and combinations thereof. The nucleating agent denotes an ingestibly acceptable compound or agent which is able to facilitate nucleation. The presence of nucleating agent in the flavoring concentrate formulation can improve the mouthfeel of the frozen Blushes of a frozen slush and to help maintain the physical properties and performance of the slush at freezing temperatures by increasing the number of desirable ice crystallization centers. Examples of nucleating agents include, but are not limited to, calcium silicate, calcium carbonate, titanium dioxide, and combinations thereof.

In one embodiment, the flavoring concentrate formulation is formulated to have a low water activity for extended shelf life. Water activity is the ratio of the vapor pressure of water in a formulation to the vapor pressure of pure water at the same temperature. In one embodiment, the flavoring concentrate formulation has a water activity of less than about 0.85. In another embodiment, the flavoring concentrate formulation has a water activity of less than about 0.80. In another embodiment, the flavoring concentrate formulation has a water activity of less than about 0.75.

In one embodiment, the flavoring concentrate formulation has the present compound in a concentration that is at least 2 times of the concentration of the compound in a ready-to-use composition. In one embodiment, the flavoring concentrate formulation has the present compound in a concentration that is at least 5 times of the concentration of the compound in a ready-to-use composition. In one embodiment, the flavoring concentrate formulation has the present compound in a concentration that is at least 10 times of the concentration of the compound in a ready-to-use composition. In one embodiment, the flavoring concentrate formulation has the present compound in a concentration that is at least 15 times of the concentration of the compound in a ready-to-use composition. In one embodiment, the flavoring concentrate formulation has the present compound in a concentration that is at least 20 times of the concentration of the compound in a ready-to-use composition. In one embodiment, the flavoring concentrate formulation has the present compound in a concentration that is at least 30 times of the concentration of the compound in a ready-to-use composition. In one embodiment, the flavoring concentrate formulation has the present compound in a concentration that is at least 40 times of the concentration of the compound in a ready-to-use composition. In one embodiment, the flavoring concentrate formulation has the present compound in a concentration that is at least 50 times of the concentration of the compound in a ready-to-use composition. In one embodiment, the flavoring concentrate formulation has the present compound in a concentration that is at least 60 times of the concentration of the compound in a ready-to-use composition. In one embodiment, the flavoring concentrate formulation has the present compound in a concentration that is up to 100 times of the concentration of the compound in a ready-to-use composition.

### Non-Animal Protein Materials and Products Made Therefrom

Products intended to replace or substitute meat or dairy products often rely on various non-animal-based materials, such as starches and proteins derived from plants, algae, and fungi, to simulate the texture and flavor of meat or dairy. Non-limiting examples of such plant proteins include soy proteins, pea proteins, bean proteins, grain proteins, and the like. Due to compositional differences between such plant-based materials and animal-derived materials, such as a lack of glutamate-containing proteins and glutathione, these products can lack the umami and/or kokumi taste that consumers associate with meat or dairy products.

Thus, in certain aspects, the disclosure provides a flavored product comprising a plant-based material (such as a plant-based starch, a plant-based protein, or a combination thereof) and the ingestible composition according to any of the aspects or embodiments set forth above. In some further embodiments, the flavored product can include any features of combination of features set forth above for ingestible compositions that contain the ingestible composition according to any of the aspects or embodiments set forth above. In some embodiments, the flavored product is a beverage, such as soy milk, almond milk, rice milk, oat milk, a protein drink, a meal-replacement drink, or other like product. In some other embodiments, the flavored product is a meat-replacement product, such as a plant-based chicken product (such as a plant-based chicken nugget), a plant-based beef product (such as a plant-based burger), and the like. In some other embodiments, the flavored product is a protein powder, a meal-replacement powder, a plant-based creamer for coffee or tea, and the like. In certain further embodiments, any such products contain additional ingredients, and have additional features, as are typically used in the preparation and/or manufacture of such products. For example, the ingestible composition according to any of the aspects or embodiments set forth above may be combined with other flavors and taste modifiers, and may even be encapsulated in certain materials, according to known technologies in the relevant art.

In some further embodiments analogous to the above embodiments, proteins or starches from algal or fungal sources can be used instead of or in combination with plant starches or proteins, which are described in greater detail above.

1. An ingestible composition comprising (a) one or more 5′-ribonucleotides; and (b) N-(heptan-4-yl)benzo[d][1,3]dioxole-5-carboxamide.

2. The ingestible composition of claim 1, wherein the one or more 5′-ribonucleotides comprise disodium inosine monophosphate, disodium guanosine monophosphate, or any combination thereof.

3. An ingestible composition comprising: (a) a yeast extract or a fermented product; and (b) N-(heptan-4-yl)benzo[d][1,3]dioxole-5-carboxamide.

4. An ingestible composition comprising: (a) glucosylated steviol glycosides; (b) a flavonoid or a dihydrochalcone; and (c) N-(heptan-4-yl)benzo[d][1,3]dioxole-5-carboxamide.

5. The ingestible composition of claim 4, wherein the ingestible composition comprises a dihydrochalcone, such as neohesperidin dihydrochalcone, hesperitin dihydrochalcone, phloretin, or any combination thereof.

6. An ingestible composition comprising: (a) a dipeptide, a tripeptide, or a combination thereof; and (b) N-(heptan-4-yl)benzo-[d][1,3]dioxole-5-carboxamide.

7. The ingestible composition of claim 6, which comprises γ-Glu-Val-Gly.

8. An ingestible composition comprising: (a) an N-acetyl amino acid; and (b) N-(heptan-4-yl)benzo-[d][1,3]dioxole-5-carboxamide.

9. The ingestible composition of claim 8, wherein the N-acetyl amino acid is N-acetylglutamic acid, N-acetylaspartic acid, or a combination thereof.

10. An ingestible composition comprising: (a) an umami-enhancing compound selected from the group consisting of (E)-3-(3,4-dimethoxyphenyl)-N-(4-methoxyphenethyl) acrylamide, 2-[3-(benzyloxy) propyl]-pyridine, (2E)-2-methyl-N-(4-{[(2E)-3-phenyl-2-propenoyl]amino}-butyl)-2-butenamide, N-[(2E)-3,7-dimethyl-2,6-octadienyl]cyclopropylcarboxamide, (E)-N-(4-cinnamamidobutyl)-4-hydroxy-2-methylbut-2-enamide, rubenamine, rubescenamine, 1-(2-hydroxy-4-methoxyphenyl)-3-(2-pyridinyl)-1-propanone, and any combinations thereof; and (b) N-(heptan-4-yl)benzo-[d][1,3]dioxole-5-carboxamide.

11. An ingestible composition comprising: (a) a 2-alkylpyridine; and (b) N-(heptan-4-yl)benzo-[d][1,3]dioxole-5-carboxamide.

12. The ingestible composition of claim 11, wherein the 2-alkylpyridine 2-pentylpyridine, 2-hexylpyridine, or a combination thereof.

13. The ingestible composition of any one of claims 1 to 12, further comprising a glutamate an aspartate, or a combination thereof.

14. The ingestible composition of any one of claims 1 to 13, further comprising a hydrolyzed vegetable protein.

15. A flavored product, which comprises an ingestible composition of any one of claims 1 to 14.
